(19) United States
(12) Patent Application Publication
(10) Pub. No.: US 2014/0358714 A1
(43) Pub. Date: Dec. 4, 2014

(54) BUTTON ENHANCEMENT FOR PROXY BIDDING

(71) Applicant: eBay Inc., San Jose, CA (US)

(72) Inventors: Hugh Evan Williams, Saratoga, CA (US); Anthony Delvecchio, San Jose, CA (US)

(73) Assignee: eBay Inc., San Jose, CA (US)

(21) Appl. No.: 14/023,199

(22) Filed: Sep. 10, 2013

Related U.S. Application Data
(60) Provisional application No. 61/829,032, filed on May 30, 2013.

(51) Int. Cl. G06Q 30/08; G06Q 30/06

(52) U.S. Cl. CPC G06Q 30/08; G06Q 30/0641
USPC 705/26.3

(57) ABSTRACT

A user interface is provided which presents a text box representing an area in which a user can enter a proxy bid for an online auction, the text box being presented within a button operable by the user to activate the proxy bid. Then input is received from the user in the text box presented within the button. The input is then placed as a bid in the online auction upon receiving a selection of the button, the selection being indicated by an activation of the button outside the area represented by the text box.

### CROSS-RELATION TO RELATED APPLICATIONS

This application claims priority to U.S. Provisional Application No. 61/829,032 filed May 30, 2013, and to U.S. Provisional Application No. 61/842,930, filed Jul. 3, 2013, both of which applications are incorporated herein by reference in their entireties.

### TECHNICAL FIELD

This application relates generally to data processing. More specifically, this application relates to button enhancement for proxy bidding.

### BACKGROUND

With the rise of mobile computing, specifically smartphones and tablets, there has been an increase in interest in new ways to shop using these new devices and their various capabilities. Online auctions are very popular with consumers. Some online auctions utilize a form of proxy bidding where the user, when entering a bid, is not specifying that the bid be entered immediately but instead is specifying a maximum bid that can be placed on the user's behalf. The auction system then only bids enough to outbid the next highest competitor's bid by a minimum increment. Many novice users, however, are confused about how proxy bidding works and assume the bid entered will be placed immediately. They get concerned when the amount they entered is not entered immediately, or if they are immediately outbid by a competitor who placed a higher maximum bid. Such novice users may suspect fraud or otherwise may simply grow frustrated with the process and not participate in any more auctions.

### BRIEF DESCRIPTION OF DRAWINGS

FIG. 1 is a network diagram depicting a client-server system, within which one example embodiment may be deployed.

FIG. 2 is a block diagram illustrating marketplace and payment applications and that, in one example embodiment, are provided as part of the networked system.

FIG. 3 is a screen capture illustrating a user interface in accordance with an example embodiment.

FIG. 4 is a screen capture illustrating a user interface in accordance with another example embodiment.

FIGS. 5-6 are screen captures illustrating a user interface in accordance with another example embodiment.

FIGS. 7-8 are screen captures illustrating a user interface in accordance with another example embodiment.

FIG. 9 is a screen capture illustrating a user interface in accordance with another example embodiment.

FIG. 10 is a flow diagram illustrating a method in accordance with an example embodiment.

FIG. 11 is a block diagram of a machine in the form of a computer system within which a set of instructions may be executed for causing the machine to perform any one or more of the methodologies discussed herein.

### DETAILED DESCRIPTION

The description that follows includes illustrative systems, methods, techniques, instruction sequences, and machine-readable media (e.g., computing machine program products) that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

In an example embodiment, button enhancements in a user interface are provided in order to make clearer to novice users how proxy bidding works and how the amount they enter as a proxy bid will be utilized by the auction system.

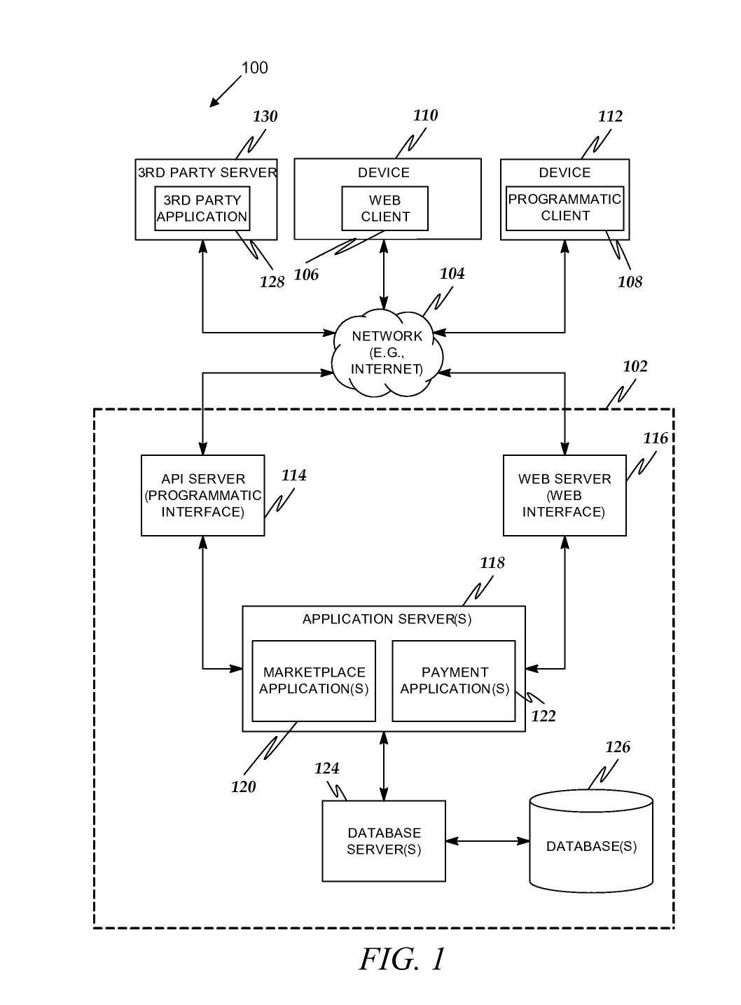

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)), to one or more clients. FIG. 1 illustrates, for example, a web client 106 (e.g., a browser, such as the Internet Explorer browser developed by Microsoft Corporation of Redmond, Wash. State) and a programmatic client 108 executing on respective devices 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

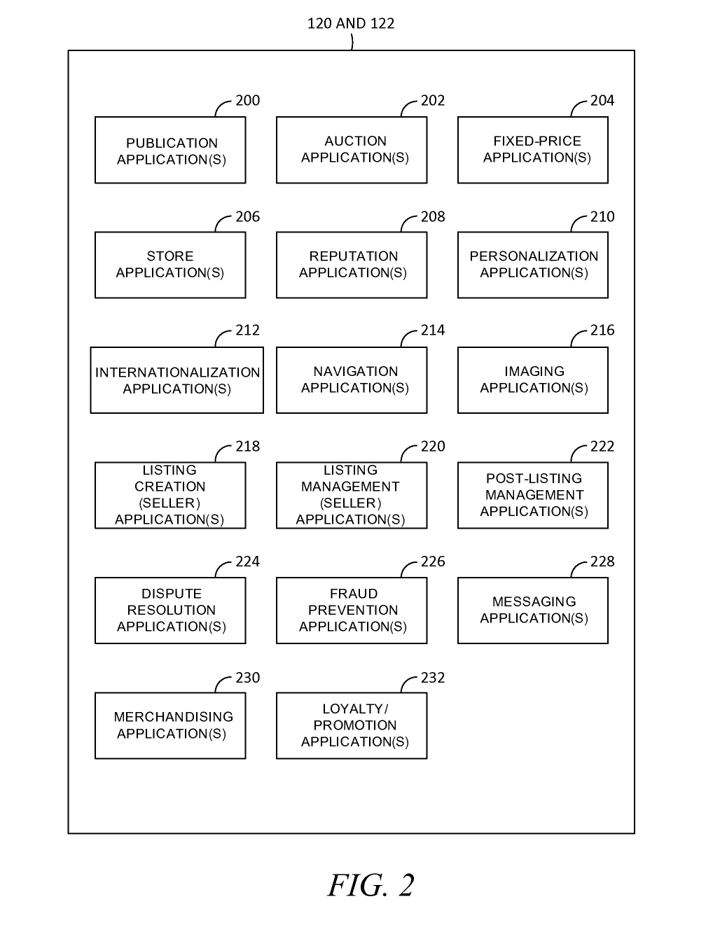

FIG. 2 is a block diagram illustrating marketplace and payment applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions, etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information by the networked system 102) according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks 104.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

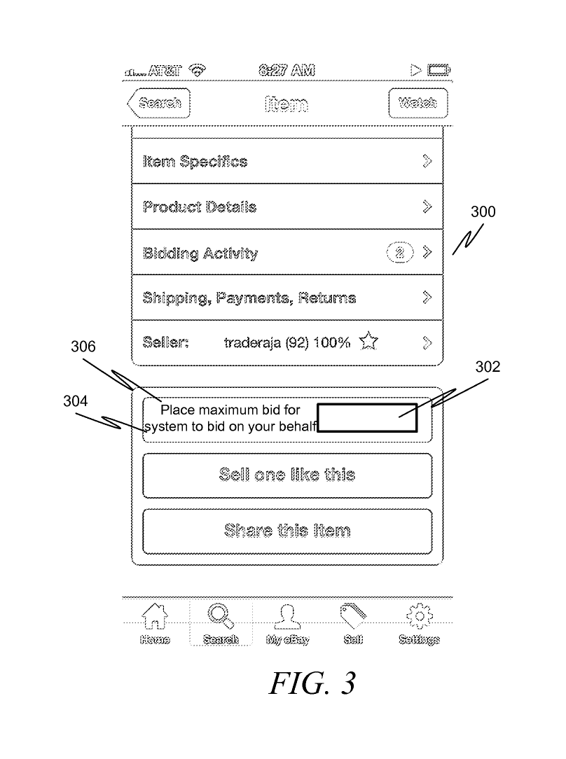

In an example embodiment, a text box where a user can enter a maximum bid can be located within a bid button itself. FIG. 3 is a screen capture illustrating a user interface 300 in accordance with an example embodiment. The user interface 300 in FIG. 3 operates in, or as part of, a dedicated application running on a mobile device 110. It should be noted that in various embodiments, the user interface can be generated and presented by server software, client software, or any suitable combination thereof. A text box 302 where the user can enter the maximum amount for the bid may be placed inside a button 304 that the user presses to place the bid. By seeing the text box 302 within the button 304, the user may be more likely to actually read the text 306 indicating what the button 304 does. This increased likelihood can be leveraged to provide additional information to the user about the proxy bidding. For example, rather than having the text 306 simply read “place bid” or some other simplistic phrase, the text 306 here indicates “place maximum bid for the system to bid on your behalf.”

The text box 302 is designed (e.g., configured) so that when a user selects the text box 302 (for example, by pressing the text box 302 with his or her finger on a touchscreen interface, or moving a cursor and clicking a mouse or other hardware button for non-touchscreen interfaces), then a cursor appears in the text box 302 and the user may type in a numerical amount using a keyboard (physical or virtual). If the user selects any area of the button 304 outside the text box 302, then the button 304 is activated and the bid amount entered in the text box 302 is utilized for bidding purposes. In some example embodiments, a subsequent screen is presented where the user can review his or her bid prior to it actually being implemented by the auction system.

In an example embodiment, an object defining the text box 302 is actually part of an object defining the button 304 itself. In other words, the interface object that represents the button 304 is designed to have an area devoted to a text box 302 and an area surrounding the text box devoted to the button 304. This is in contrast to, for example, overlaying a text box object on top of a button object.

It should be noted that while the present disclosure describes the text box being used to inform users about proxy bidding, in other example embodiments the text box could also be used inside buttons devoted to other activities. Such examples may include, but are not limited to, non-proxy bidding in an online auction, live auction bidding, bidding a minimum amount required, e-commerce purchases, placing a best offer in a fixed price listing, purchasing more than one of a particular listed item, etc.

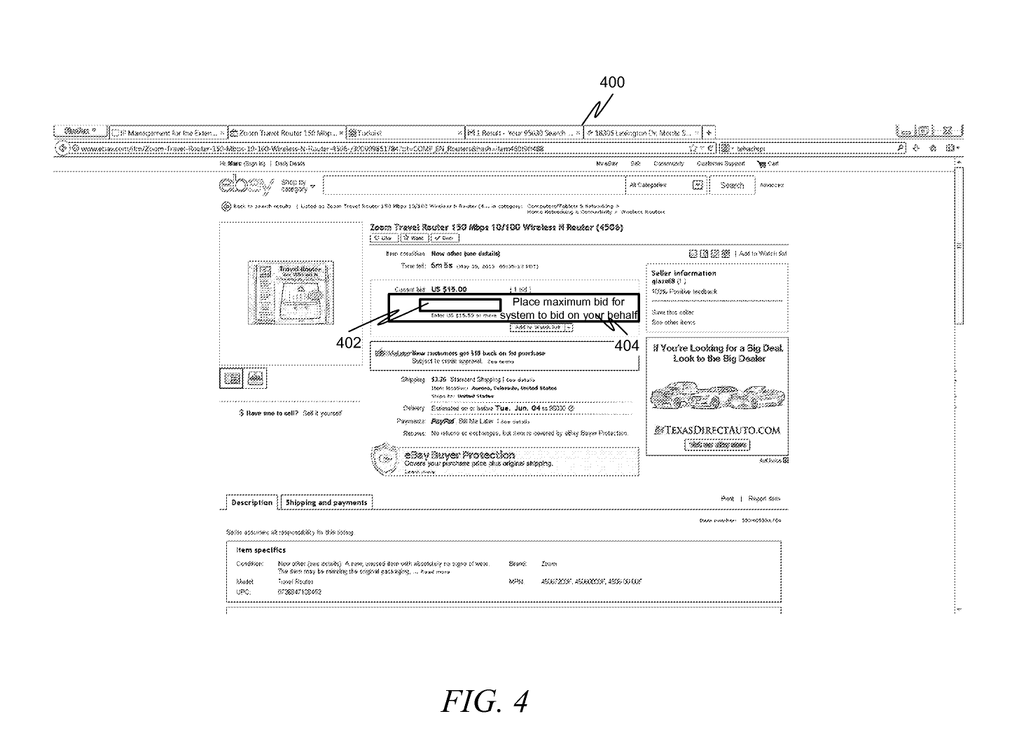

FIG. 4 is a screen capture illustrating a user interface 400 in accordance with another example embodiment. The user interface 400 in FIG. 4 operates in, or as part of, a web browser operating, for example, on a desktop or laptop computer. As with FIG. 3, text box 402 operates inside the button 404. Operationally, the user interface 400 shown in FIG. 4 may execute similarly to the user interface 300 shown in FIG. 3.

In an example embodiment, button enhancements may or may not be provided based on the experience level of the user. Users who have a lot of experience with online auctions are less likely to need further explanation of how proxy bidding works than users with little experience. As such, users may be assigned experience levels. These levels may be determined based on number of factors, for example, the number of auctions the user has participated in, the amount of time the user's account has been established, the age of the user. A predetermined threshold may then be compared against a user's experience level to determine whether or not to present one or more of the button enhancements described in this disclosure. In an example embodiment, there may be different types of button enhancements for different levels. For example, users may not simply be classified as “beginner” or “experienced” but presented with a level number from 1 to 10, with each level number having its own button enhancements explaining proxy bidding.

In another example embodiment, a button enhancement is provided wherein the user is presented with other options than proxy bidding. For example, the user may be presented with an option to proxy bid or an option to simply enter a fixed single bid. In some example embodiments, the system 102 may simply present the user with a bid amount that represents the next highest available bid (e.g., the current bid amount plus a predetermined bid increment), and the user simply is informed that pressing a bid button 304 places this next highest bid.

In another example embodiment, a bid strategy is provided for the user in or near the bid button 304. For example, rather than simply presenting an empty text box 302 for entry of a bid amount, the system may prepopulate the text box 302 with a suggested bid amount. This suggested bid amount may be based, for example, on past usage information for the user, on typical prices for similar items, or on both. This way, a bid strategy can be presented that is tailored for this particular user and item. In an example embodiment, the suggested bid amounts or bid strategies may be dynamically updated based on what the user is typing in the text box 302. For example, if the user starts typing a “1”, the system may recognize that similar items typically sell in the $100-200 range even though the current bid is $75, and the system may automatically populate the rest of the bid with zeros to make the bid $100. In an alternative example, a user placing a maximum bid that is too high may be presented with information indicating that such a bid may be risky.

In another example, sources of information unrelated to an online auction may be used to determine a suggested bid amount. For example, sales of items on traditional (i.e., non-auction) e-commerce sites can be used to determine costs, as well as marketing databases or other sites.

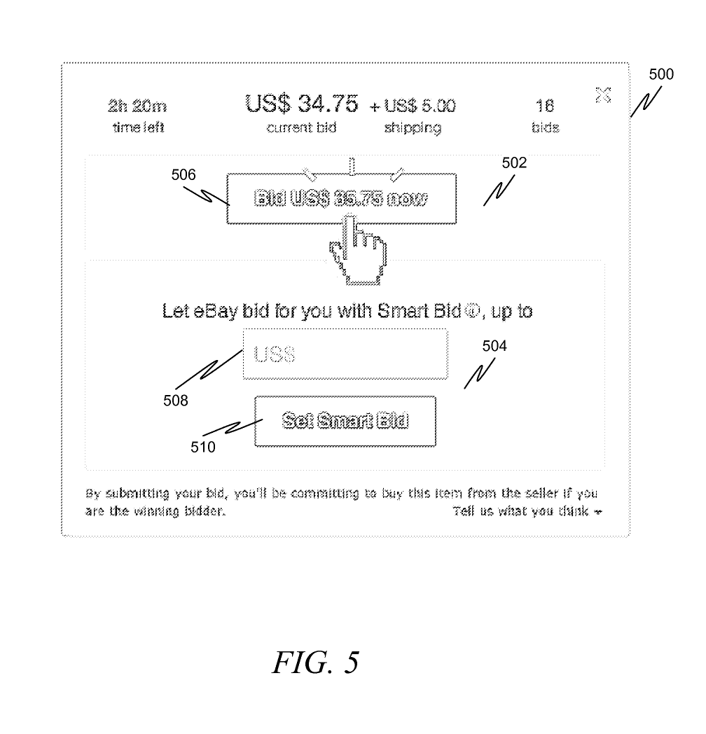

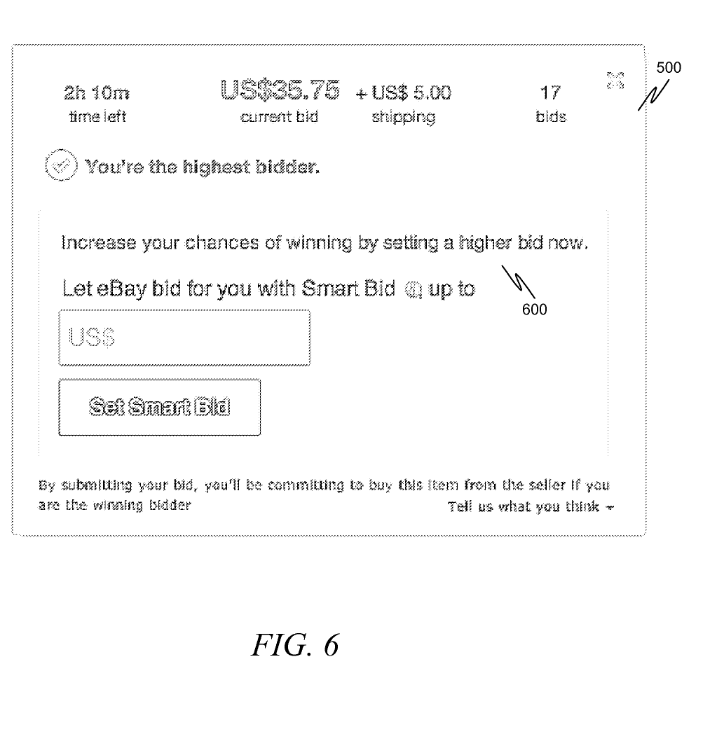

FIGS. 5-6 are screen captures illustrating a user interface 500 in accordance with another example embodiment. Here, the user interface 500 presents two separate bidding areas 502, 504. In bidding area 502, the user is able to place a bid reflecting a next highest bid (current bid plus a bid increment) without needing to type in a bid. The button 506 indicates the exact amount being bid. In other words, the next highest bid (current bid plus bid increment) is calculated and placed within the button 506 itself, so it is clear exactly how much the user is bidding by pressing the button 506.

In bidding area 504, a smart bid is permitted. A smart bid is another term for a proxy bid, and a text box 508 is provided to allow the user to enter the maximum amount of the proxy bid. A set smart bid button 510 then indicates that pressing the button 510 sets the smart bid, making it clear that a proxy bid is being placed, especially in contrast to button 506.

FIG. 6 illustrates the user interface 500 when the user presses button 506 in FIG. 5. As can be seen, an opportunity is provided for the user to still enter a smart bid by using bidding area 600, which also includes an explanation of what happens if a smart bid is entered (“Let eBay bid for you”).

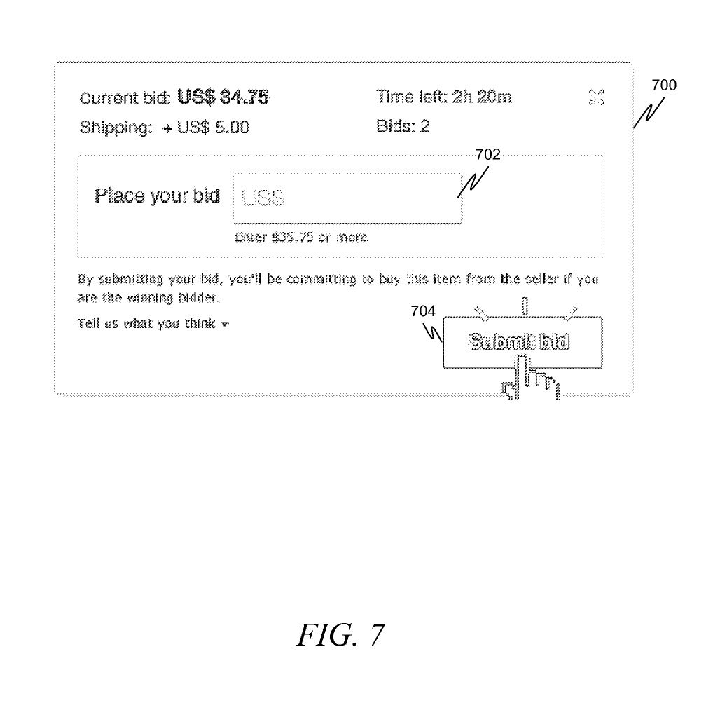

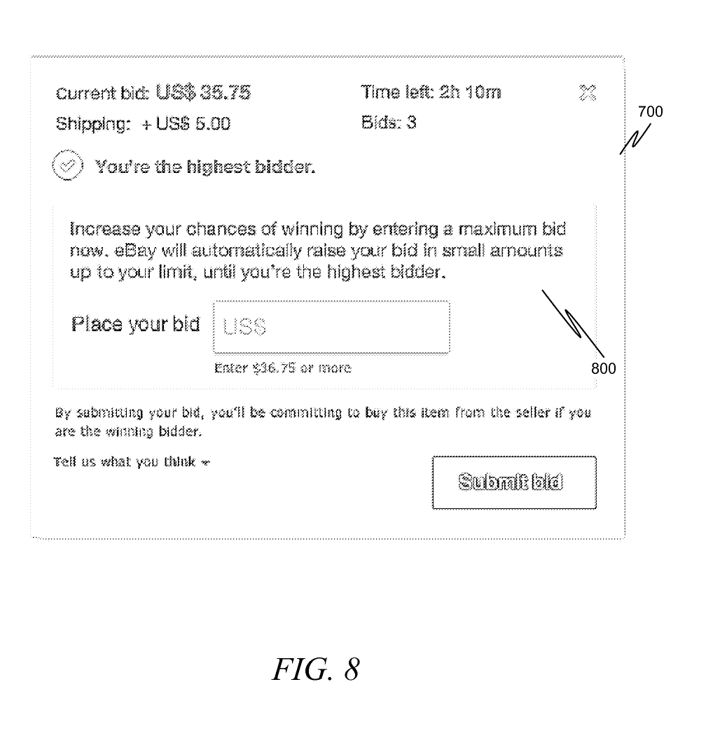

FIGS. 7-8 are screen captures illustrating a user interface 700 in accordance with another example embodiment. Here, the user interface 700 presents a bidding window with a text box 702 and a button 704. The button 704 is used to simply submit the bid entered in the text box 702. FIG. 8 illustrates the user interface 700 when the user enters a bid in text box 702 and presses button 704 in FIG. 7. Here, rather than merely confirming the entered bid, the user is presented with a smart bid area 800, where the user is able to enter a proxy bid higher than the newly entered bid, along with an explanation of how proxy bidding works (“eBay will automatically raise your bid in small amounts up to your limit, until you're the highest bidder”).

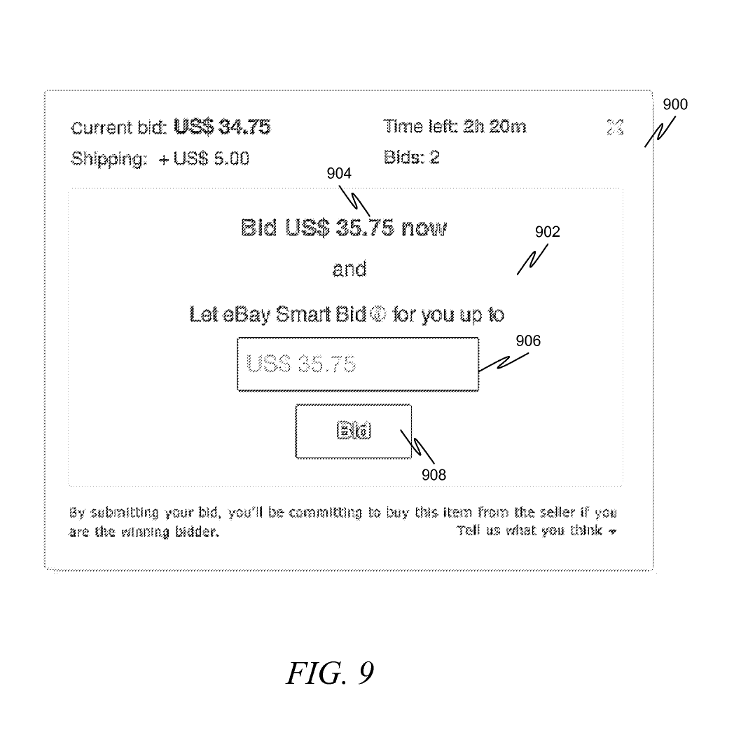

FIG. 9 is a screen capture illustrating a user interface 900 in accordance with another example embodiment. Here, the user interface 900 presents a combined bid and smart bid area 902. The user is automatically presented with a calculated bid 904 (current high bid plus a bidding increment). The user also is then presented with a text box 906 where the user can enter a different bid, as well as a bid button 908. Here, if the user does not enter a bid in the text box 906 prior to pressing the bid button 908, then the system simply places a bid equal to the calculated bid 904. If the user does enter a bid in the text box 906 prior to pressing the bid button 908, then the system utilizes the entered bid as a proxy bid for the auction.

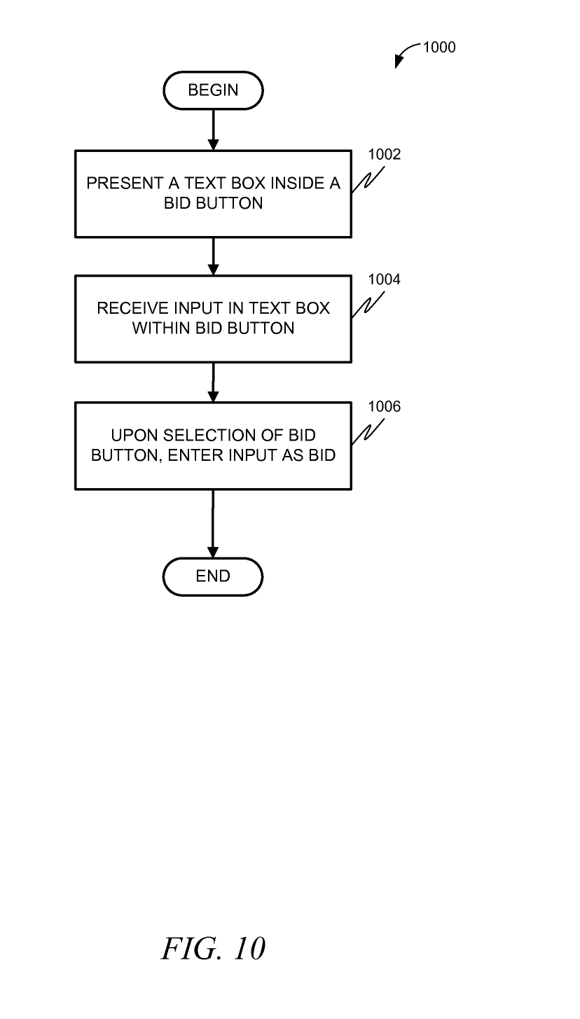

FIG. 10 is a flow diagram illustrating a method 1000 in accordance with an example embodiment. At operation 1002, a text box 906 representing an area where a user can enter a proxy bid for an online auction is presented within a button 908 where the user can activate the proxy bid. At operation 1004, input is received from the user in the text box 906 within the button 908. At operation 1006, the input is placed as a bid in the online auction upon receiving a selection of the button 908 outside an area defining the text box 906.

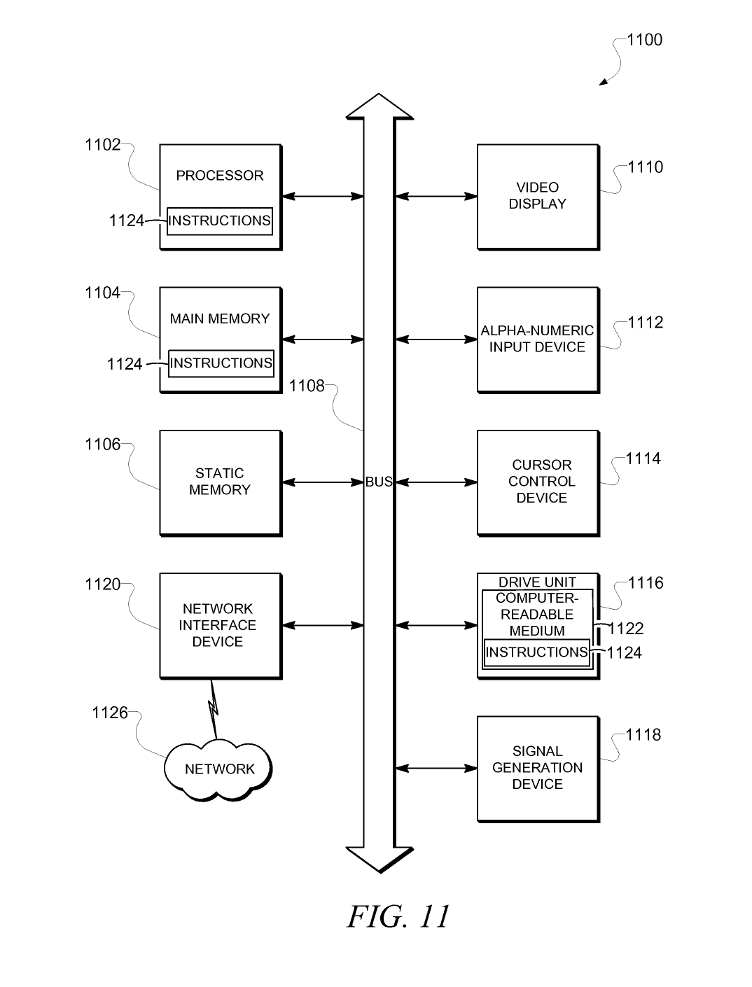

FIG. 11 is a block diagram of a machine in the form of a computer system within which a set of instructions may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In one embodiment, the machine will be a server computer; however, in alternative embodiments, the machine may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a display unit 1110, an alphanumeric input device 1112 (e.g., a keyboard), and a user interface (UI) navigation (e.g., cursor control) device 1114 (e.g., a mouse). In one embodiment, the display, input device 1112 and cursor control device 1114 are a touch screen display. The computer system 1100 may additionally include a storage device (e.g., drive unit) 1116, a signal generation device 1118 (e.g., a speaker), a network interface device 1120, and one or more sensors (not pictured) such as a global positioning system sensor, compass, accelerometer, or other sensor.

The drive unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media 1122.

While the machine-readable medium 1122 is illustrated in an example embodiment to be a single medium, the term “machine-readable medium” may include a single medium or multiple media (e.g., a centralized or distributed database, and/or associated caches and servers) that store the one or more instructions 1124. The term “machine-readable medium” shall also be taken to include any tangible medium that is capable of storing, encoding or carrying instructions 1124 for execution by the machine and that cause the machine to perform any one or more of the methodologies of the embodiments of the present disclosure, or that is capable of storing, encoding or carrying data structures utilized by or associated with such instructions 1124. The term “machine-readable medium” shall accordingly be taken to include, but not be limited to, solid-state memories, and optical and magnetic media. Specific examples of machine-readable media 1122 include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The instructions 1124 may further be transmitted or received over a communications network 1126 using a transmission medium via the network interface device 1120 utilizing any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi® and WiMax® networks). The term “transmission medium” shall be taken to include any intangible medium that is capable of storing, encoding or carrying instructions 1124 for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. An apparatus comprising:
a processor;
a memory;
a user interface executable by the processor and utilizing the memory, the user interface being configured to:
present a text box representing an area in which a user can enter a proxy bid for an online auction, the text box being presented within a button operable by the user to activate the proxy bid;
receive input from the user in the text box presented in the button; and
place the input as a bid in the online auction upon receiving a selection of the button, the selection being indicated by an activation of the button outside the area represented by the text box.

2. The apparatus of claim 1, wherein the button is a user interface object and the text box is part of the user interface object of the button.

3. The apparatus of claim 1, wherein the user interface is further configured to present a description of how proxy bidding works inside the button but outside of the text box.

4. The apparatus of claim 1, wherein the user interface is further configured to:
determine an experience level of the user; and
move the text box outside of the button if the experience level of the user is above a predetermined threshold.

5. The apparatus of claim 1, wherein the user interface is further configured to prepopulate the text box with a suggested bid amount.

6. The apparatus of claim 5, wherein the suggested bid amount is based in part on past usage information for the user.

7. The apparatus of claim 5, wherein the suggested bid amount is based in part on typical prices for items similar to an item for sale in the online auction.

8. A method comprising:
presenting a text box representing an area in which a user can enter a proxy bid for an online auction, the text box being presented within a button operable by the user to activate the proxy bid;
receiving input from the user in the text box; and
placing the input as a bid in the online auction upon receiving a selection of the button, the selection being indicated by an activation of the button outside the area represented by the text box.

9. The method of claim 8, wherein the button is a user interface object and the text box is part of the user interface object of the button.

10. The method of claim 8, further comprising presenting a description of how proxy bidding works inside the button but outside of the text box.

11. The method of claim 8, further comprising:
determining an experience level of the user; and
moving the text box to outside of the button if the experience level of the user is above a predetermined threshold.

12. The method of claim 8, further comprising prepopulating the text box with a suggested bid amount.

13. The method of claim 12, wherein the suggested bid amount is based in part on past usage information for the user.

14. The method of claim 12, wherein the suggested bid amount is based in part on typical prices for items similar to an item for sale in the online auction.

15. A non-transitory computer-readable storage medium comprising instructions that, when executed by at least one processor of a machine, cause the machine to perform operations comprising:
presenting a text box representing an area in which a user can enter a proxy bid for an online auction, the text box being presented within a button operable by the user to activate the proxy bid;
receiving input from the user in the text box; and
placing the input as a bid in the online auction upon receiving a selection of the button, the selection being indicated by an activation of the button outside the area represented by the text box.

16. The non-transitory computer-readable storage medium of claim 15, wherein the button is a user interface object and the text box is part of the user interface object of the button.

17. The non-transitory computer-readable storage medium of claim 15, further comprising:
determining an experience level of the user; and
moving the text box to outside of the button if the experience level of the user is above a predetermined threshold.

18. The non-transitory computer-readable storage medium of claim 15, further comprising prepopulating the text box with a suggested bid amount.

19. The non-transitory computer-readable storage medium of claim 18, wherein the suggested bid amount is based in part on past usage information for the user.

20. The non-transitory computer-readable storage medium of claim 18, wherein the suggested bid amount is based in part on typical prices for items similar to an item for sale in the online auction.
